(19) United States
(12) Patent Application Publication
(10) Pub. No.: US 2003/0043411 A1
(43) Pub. Date: Mar. 6, 2003

(54) Method and device for the transformation of images in two co-ordinate systems

(76) Inventor: Bernhard Frei, Konstanz (DE)

Correspondence Address: SCHIFF HARDIN & WAITE, 6600 SEARS TOWER, 233 S WACKER DR, CHICAGO, IL, 60606-6473, US

(21) Appl. No.: 10/220,007

(22) PCT Filed: Feb. 22, 2001
(86) PCT No.: PCT/EP01/02027

(30) Foreign Application Priority Data
Feb. 29, 2000 (DE) 100 09 536.4

(51) Int. Cl. B41J 1/00; G06F 15/00; H04N 1/40

(52) U.S. Cl. 358/3.01; 358/1.9

(57) ABSTRACT

The invention relates to a method and a device for the transformation of an image represented by grey tone values and/or colour valence values in a first co-ordinate system into a second co-ordinate system. According to this method, a relationship is created between the co-ordinates of source image pixels in an initial image and the co-ordinates of target image pixels in a target image, using a transformation matrix, in which co-ordinates of the target image pixels belonging to the natural value range can correspond with co-ordinates of the source image pixels which fall within the real value range and vice versa. Adjacent pixels are then taken into account in the determination of the valence values of a target image pixel, in which auxiliary co-ordinates are determined from the co-ordinates of two respective sequential source image pixels, in such a way that two target image pixels can be calculated from this.

### SPECIFICATION

Method and device for the transformation of images in two coordinate systems

The invention relates to a method and a device for the transformation of an image described by gray scale valency values and/or color valency values in a first coordinate system into a second coordinate system, comprising the following steps: a) providing a relationship between the coordinates of source image pixels in a source image and the coordinates of target image pixels in a target image by using a transformation matrix, wherein coordinates of the target image pixels belonging to the natural number range of values can correspond with coordinates of the source image pixels which fall within the real number range of values, and vice versa; and b) taking account of the neighbouring pixels in the determination of the valency value of a target image pixel.

The application of such methods is, for example, required after the scanning of documents. When scanning documents, these documents are pulled across the scanning location in a more or less skew manner due to mechanical tolerances of the course of the document or due to documents that are not sufficiently aligned, as a result whereof the documents are also imaged in a skew manner.

This skewed position is generally found disturbing. The post-processing of non-aligned images is particularly tiring and costly since an image having the area of the rectangle circumscribing the skewed image has to be stored every time. As a result thereof, the memory requirement is increased. In case that an automatic character recognition is implemented, the skewed position increases the calculation expense for the character recognition.

In particular, for pure binary scanners for the automatic document processing, an electronic correction of such skewed positions is the state of the art. However, in the case of gray scanners and color scanners, this correction of the skewed position is not a matter of course.

The reason for that is, among others, that the binary data of an image can easily be stored in an SRAM memory which, with regard to its access speed, can keep up with the processing power of an arithmetic unit.

The memory requirement of a color image is, however, higher by factors of 16 to 32 than in the case of black/white images or, respectively, binary images. Given scanners for document sizes as from DIN-A4, this requires an intermediate storage in DRAMs for reasons of costs and space. The DRAMs, however, only allow an access speed that, given a direct addressing, lies approximately at one-fifth of the SRAMs.

The basis of the method mentioned in the first part of claim 1 is the determination of the coordinates of a point X_{Quell} (X_{source}) in the source image in correspondence with the coordinates of a point X_{Ziel} (X_{target}) in the target image by using a transformation matrix T, which determination is generally known from the literature. The matrix T can, in a way known per se, be defined differently depending on the transformation to be carried out.

When using a homogeneous coordinate system, the matrix T can, for example, have the following definition:

cos (Ø)/Sy sin (Ø)/S_{y}0

T=−sin (Ø)/Sₓ cos (Ø)/Sₓ0

0 0 1

With this matrix, an image rotation required, for example, for the correction of the skewed position can be implemented, Ø being the angle of rotation.

The correction of the skewed position is merely a special case of the rotation by arbitrary angles. It is a special case because for mechanical reasons usually only angles of rotation Ø occur which lie in the range of about +/−10 degrees.

The invention, however, is not restricted to this angular range but can be used for arbitrary angular ranges.

S_{y} and Sₓ are scaling factors by which the rotation can be combined with a scaling.

The source image vector q=[y_{q}, x_{q}] then belongs to a target image vector z=[y_{z}, x_{z}], the elements of which source image vector are determined from T according to

q=Tz.

As a result thereof, the following defining equations are obtained:

y_{q}=+cos (Ø)*y_{z}/S_{y}+sin (Ø)* x_{z}/S_{y}

x_{q}=−sin (Ø)*y_{z}/Sₓ+cos (Ø)* x_{z}/Sₓ

In the determination of the source image coordinates for angles

Ø≠n*π/4 there will result coordinate values in the range of values R for the coordinate values of the target image coordinates with the range of values N.

Since the pixels of the source image are, however, only represented by discrete lattice points, an allocation problem can arise.

While in the case of binary images one can help oneself well by selecting the source image pixel having the shortest distance to the exact source image location, for gray and color images, this method results in disturbing staircase curves at the edges.

A common method for eliminating this problem is the bilinear interpolation.

For the determination of the gray scale valency values and/or color valency values of the target image, the four neighbouring pixels are used and are weighted with the share of the fractional digits:

dₓ=x_{q}−frac(x_{q})

d_{y}=y_{q}−frac(y_{q}) wherein:

pix00=qpix00*(1.0-dₓ)

pix01=qpix01*dx

pix10=qpix10*(1.0-dₓ)

pix11=qpix11*dₓand:

s_{y,x}=(pix00-pix01)*(1.0-dy)−(pix10-pix11)* d_{y}.

Thus, for each target image pixel the values of the four neighbouring pixels are required.

Compared to the capacity required for the transport of the image, this results in an increase in the required channel capacity by four times when the memory is accessed.

From EP-A-0 280 316, a method for the transformation of an image from a first coordinate system into a second coordinate system is known. With the aid of filter coefficients of a filter system and a specific weighting, an image distortion can be counteracted.

DE-A-19715491 discloses an interpolation method for a fast image enlargement. Image pixels of a target image are determined from the image pixels of a source image, a repeated reading of the same image pixels of the source image not being necessary. Weighted functions are used for the transformation.

In DE-A-19601564, a digital interpolation device for images is disclosed, in which an image transformation takes place. The transformation is implemented with the aid of interpolation coefficients.

The present invention is based on the object to specify a method, wherein the required channel capacity during memory access is lower.

This object is solved by the features given in claim 1.

Advantageous embodiments and developments of the invention result from the subclaims.

According to the invention, taking account of the neighbouring pixels in the determination of the valency value of a target image pixel is carried out such that auxiliary coordinates are determined from the coordinates of two respective successive source image pixels, from which auxiliary coordinates two target image pixels can be calculated so that the required channel capacity towards the memory is halved.

The calculation rule for the determination of the auxiliary coordinates is preferably selected such that it results in an error as small as possible while it can be realized simply with regard to the hardware.

A possible rule for the determination of the auxiliary coordinates is as follows:

Y_{hquell}=(y_{q}+y_{q+1})/2

X_{hquell}=(x_{q}+x_{q+1})/2.

From these auxiliary coordinates X_{hquell}, Y_{hquell}, then weightings d_{xq}, d_{yq}, d_{xq+1}, d_{yq+1}can be determined using the following pairs of differences:

d_{xq}=x_{q}−frac(x_{hquell})

d_{yq}=y_{q}−frac(y_{hquell})

d_{xq+1}=x_{q+1}−frac(x_{hquell})

d_{yq+1}=y_{q+1}−frac(y_{hquell}).

Thus, for each quadruple of the source pixels, two pairs of the differences are determined. But while these weightings lie in the range of values from 0 to 1 given the standard form of the bilinear interpolation, the weightings determined by the rule mentioned can lie outside these limits. This means, however, that portions of pixels outside the pixels currently available would have to be included.

In order to avoid this, the weightings are preferably truncated according to the following rule:

d_{y}=d_{y} if 0≦d_{y}≦1.0

d_{y}=1.0 if d_{y}>1.0

d_{y}=0 if d_{y}<0

dₓ=dₓif 0 ≦dₓ≦1.0

dₓ=1.0 if dₓ>1.0

dₓ=0 if dₓ<0.

In the determination of the target pixel data, an error occurs which can be defined as a standard error e for the transformation of an image having the height M and the width N as follows:

M N

e=(ΣΣ[1-((1-f(x_{q},x_{hquell})f(y_{q-y}_{hquell})+1−((1-f_{xq+1},x_{hquell}) (1-f(y_{q+1},y_{hquell}))]/(M*N) wherein:

f(u,v)=−(u-v) if u-v>0

f(u-v)=u-v-1 if u-v>1

f(u,v)=0 otherwise.

This error cannot be determined in closed form due to the truncation of the fractional digits of the coordinates. From a simulation with regard to different image sizes and angles, however, there results that this error is (naturally) 0 if Ø≠n* π/4 and lies between 12 and 15% (otherwise). In the case of natural scenes, this error is hardly noticable, at sharp edges an effect can only be recognized when they are directly focussed on.

Embodiments of the invention are explained in more detail with reference to the drawings.

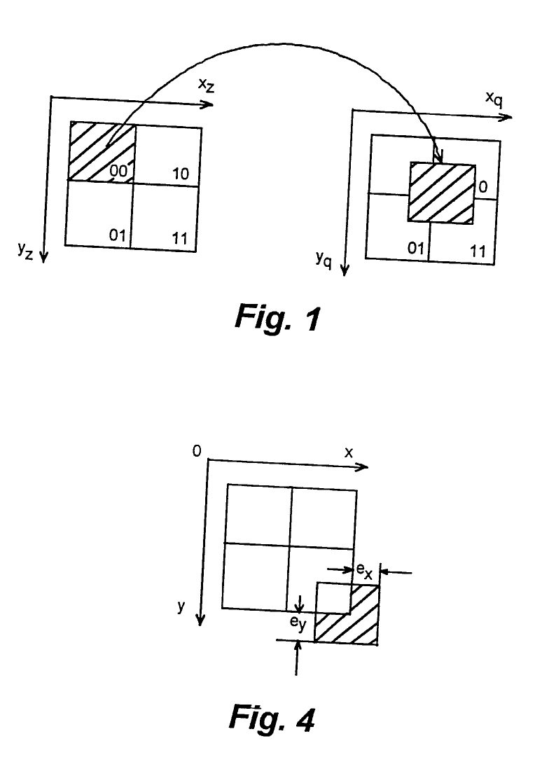

FIG. 1 is an illustration of an allocation problem possibly arising during the image transformation.

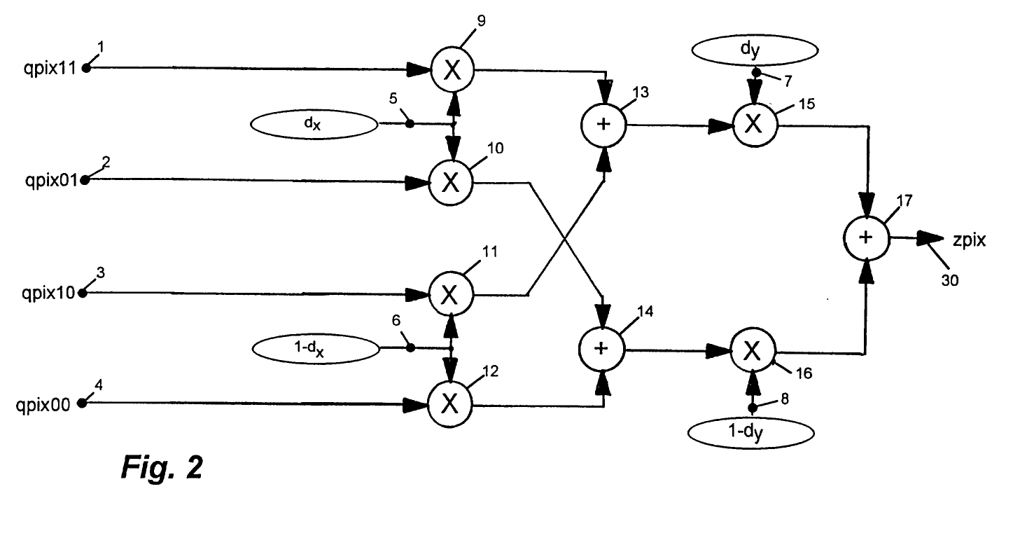

FIG. 2 is a block circuit diagram of a circuit for implementing the known bilinear interpolation.

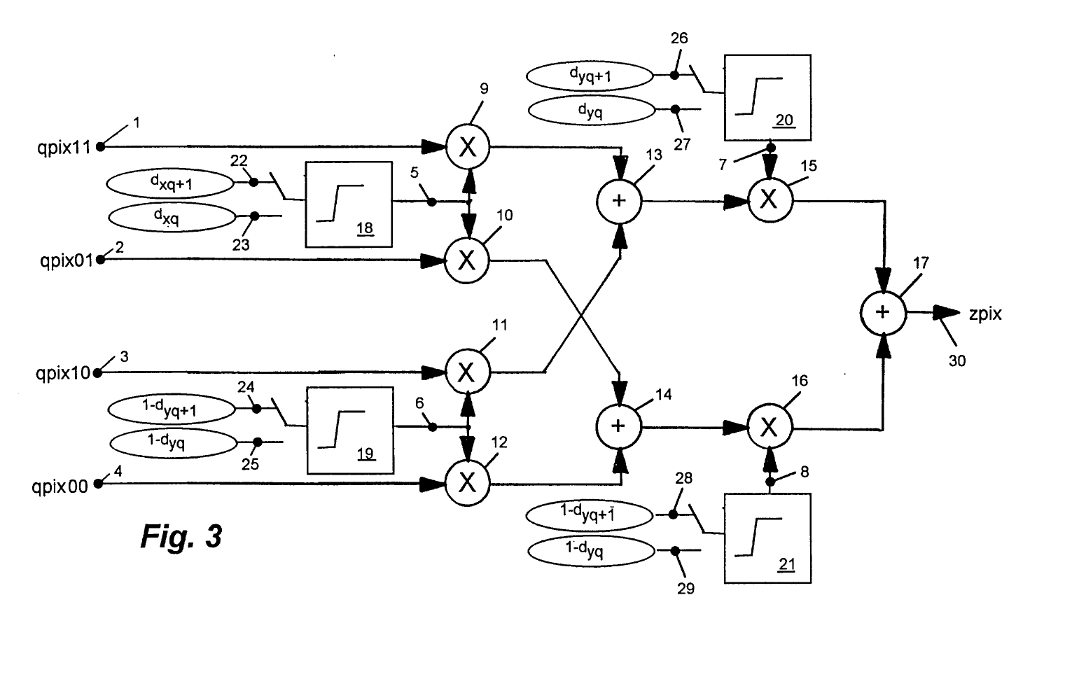

FIG. 3 is a block circuit diagram of a circuit for implementing the method of the invention.

FIG. 4 shows an illustration of the error occurring in the bilinear interpolation.

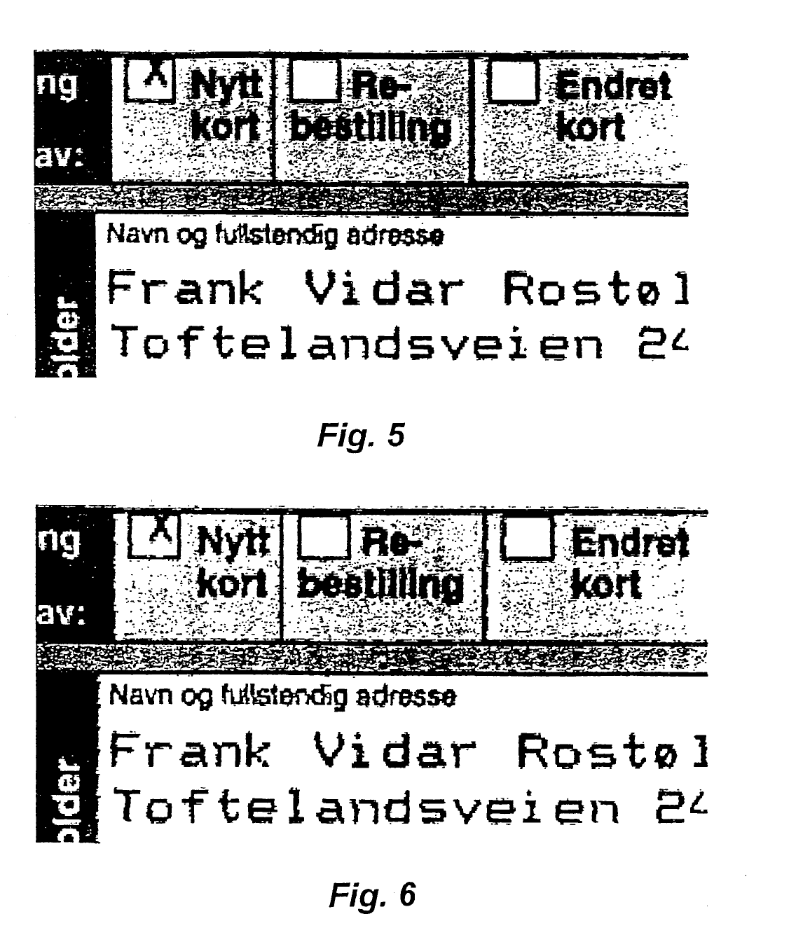

FIG. 5 shows a document that has been rotated with the bilinear interpolation by 5.6 degrees.

FIG. 6 shows a document that has been rotated by 5.6 degrees with the method of the invention.

FIG. 1 illustrates the mapping problem arising due to the transformation of the image from one coordinate system into another coordinate system.

The coordinates of the target image pixels belonging to the natural number range of values N correspond with coordinates of the source image pixels falling in the real number range of values R.

Up to now, the bilinear interpolation has been used for solving this problem.

In FIG. 2, a block circuit diagram of a circuit is illustrated to which signals obtained from the results of the bilinear interpolation are supplied.

For comparison, FIG. 3 shows a block circuit diagram of a circuit using the method according to the invention.

The circuits shown in FIGS. 2 and 3 basically have the same structure, corresponding components being provided with the same reference signs.

Both circuits have input terminals 1, 2, 3, 4, to which pixel data qpix11, qpix01, qpix10, qpix00 are supplied. Further, input terminals 5, 6, 7, 8 are provided, to which signals are supplied that are obtained from weightings which were either determined according to the state of the art (FIG. 2) or according to the present invention (FIG. 3). The output terminal has the reference sign 30 in both Figures.

The inputs of a first multiplier 9 are connected to the input terminals 1 and 5. The inputs of a second multiplier 10 are connected to the input terminals 2 and 5. The inputs of a third multiplier 11 are connected to the input terminals 3 and 6, and the input terminals of a fourth multiplier 12 are connected to the input terminals 4 and 6.

The output signal of the first multiplier 9 and the output signal of the third multiplier 11 are supplied to a first adder 13, whereas the output signal of the second multiplier 10 and the output signal of the fourth multiplier 12 are supplied to a second adder 14.

The inputs of a fifth multiplier 15 are connected to the input terminal 7 and the output of the first adder 13.

Similarly, the inputs of a sixth multiplier 16 are connected to the input terminal 8 and the output of the adder 14.

The inputs of a third adder 17 are connected to the outputs of the fifth and the sixth multiplier, the output of the adder 17 forming the output terminal 30, at which the signal zpix can be taken off.

In the circuit according to FIG. 2, the signal dₓ=x_{q}−frac(x_{q}) is applied to the input terminal 5, whereas the signal 1-dₓ=1−(x_{q}−frac(x_{q})) is supplied to the input terminal 6. Further, the signal d_{y}=y_{q}−frac(y_{q}) is supplied to the input terminal 7 and the signal 1-d_{y}=1−(y_{q}frac(y_{q}) is supplied to the input terminal 8. Given this wiring, the circuit according to FIG. 2 provides the pixel data zpix generated with the aid of the known bilinear interpolation at the output terminal 30.

As mentioned, given this way of proceeding, however, for each target image pixel the values of the four neighbouring pixels are required, which results in an increase in the required channel capacity by four times when the memory is accessed compared to the capacity required for the transport of the image.

This problem is reduced by the wiring of the circuit according to FIG. 3, inasmuch as the required channel capacity towards the memory is halved.

To this end, according to FIG. 3, the outputs of clock-controlled changeover switches or multiplexers 18, 19, 20, 21 are connected to the input terminals 5, 6, 7, 8. The clock-controlled changeover switch 18 connected to the input terminal 5 has itself two input terminals 22, 23. The clock-controlled changeover switch 19 connected to the input terminal 6 has two input terminals 24, 25, whereas the clock-controlled changeover switch 20 connected to the input terminal 7 has the two input terminals 26, 27. Finally, the changeover switch 21 connected to the input terminal 8 has the two input terminals 28 and 29.

The clock-controlled changeover switches 18, 19, 20, 21 operate such that either the terminals 22 and 5, 24 and 6, 26 and 7, 28 and 8 or the terminals 23 and 5, 25 and 6, 27 and 7, 29 and 8 are connected.

The signal d_{xq+1} is supplied to the terminal 22, the signal d_{xq} is supplied to the terminal 23, the signal 1-d_{yq+1} is supplied to the terminal 24, the signal is 1-d_{yq} is supplied to the terminal 25, the signal d_{yq+1} is supplied to the terminal 26, the signal d_{yq} is supplied to the terminal 27, the signal 1-d_{yq+1} is supplied to the terminal 28 and the signal 1-d_{yq} is supplied to the terminal 29.

The signals or, respectively, the values d_{xq}, d_{yq}, d_{xq+1} and d_{yq+1} are determined according to the above explanations.

Given this wiring of the circuit, the method according to the invention is realized, it being possible that the target pixel data are taken off at the output terminal 30.

The circuit corresponding to the block circuit diagram of FIG. 3 is easy to implement and, in addition, has the advantage that the standard form of the bilinear interpolation can likewise be determined without any additional expense. For this, the coordinate counter only has to generate the same address twice.

In FIG. 4, the error e occurring in the known bilinear interpolation is illustrated. The shaded area indicates the area portion e=f(eₓ,e_{y}) of the pixel that is determined from the neighbouring pixels under the bilinear interpolation.

FIG. 5 is a partial view of a document that has been rotated with bilinear interpolation by 5.6 degrees.

For comparison, FIG. 6 is a partial view of the same document that has been rotated by 5.6 degrees with the method of the invention.

In natural scenes, the error can hardly be noticed. Merely at sharp edges an effect can be recognized when directly focussing on these edges, as is confirmed by a comparison of FIG. 5 and FIG. 6.

List of reference signs

| | |
|---|---|
| 1 | input terminal |
| 2 | input terminal |
| 3 | input terminal |
| 4 | input terminal |
| 5 | input terminal |
| 6 | input terminal |
| 7 | input terminal |
| 8 | input terminal |
| 9 | multiplier |
| 10 | multiplier |
| 11 | multiplier |
| 12 | multiplier |
| 13 | adder |
| 14 | adder |
| 15 | multiplier |
| 16 | multiplier |
| 17 | adder |
| 18 | clock-controlled changeover switch |
| 19 | clock-controlled changeover switch |
| 20 | clock-controlled changeover switch |
| 21 | clock-controlled changeover switch |
| 22 | input terminal |
| 23 | input terminal |
| 24 | input terminal |
| 25 | input terminal |
| 26 | input terminal |
| 27 | input terminal |
| 28 | input terminal |
| 29 | input terminal |
| 30 | output terminal |
| qpix00 | pixel data |
| qpix01 | pixel data |
| qpix11 | pixel data |
| qpix10 | pixel data |

1. A method for the transformation of an image described by gray scale valency values and/or color valency values (s) in a first coordinate system into a second coordinate system, comprising the following steps:
a) providing a relationship between the coordinates of source image pixels (qpix) in a source image and the coordinates of target image pixels (zpix) in a target image by using a transformation matrix (T), wherein coordinates of the target image pixels (zpix) belonging to the natural number range of values (N) can correspond with coordinates of the source image pixels (qpix) falling in the real number range of values, and vice versa; and
b) taking account of the neighbouring pixels in the determination of the valency value (s) of a target image pixel (zpix);
characterized in that in step b) auxiliary coordinates (x_{hquell}, y_{hquell}) are determined from the coordinates of two respective successive source image pixels (qpix_{x,y}) such that two target image pixels can be calculated therefrom.

2. The method according to claim 1, characterized in that the determination of the auxiliary coordinates is carried out according to the following rule:
Y_{hquell}=(y_{q}+y_{q+1})/2
X_{hquell}=(x_{q}+x_{q+1})/2.

3. The method according to claim 2, characterized in that weightings (d_{xq}, d_{yq}, d_{xq+1}, d_{yq+1}) are determined from the following pairs of differences with the aid of the auxiliary coordinates (x_{hquell}, y_{hquell}):
d_{xq}=x_{q}−frac(x_{hquell})
d_{yq}=y_{q}−frac(y_{hquell})
d_{xq+1}=x_{q+1}−frac(x_{hquell})
d_{yq+1}=y_{q+1}−frac(y_{hquell}).

4. The method according to claim 3, characterized in that the weightings (d_{xq}, d_{yq}, d_{xq+1}, d_{yq+1}) are truncated according to the following rule:
d_{y}=d_{y} if 0≦d_{y}≦1.0
d_{y}=1.0 if d_{y}>1.0
d_{y}=0 if d_{y}<0
dₓ=dₓ if 0≦dₓ≦1.0
dₓ=1.0 if dₓ>1.0
dₓ=0 if dₓ<0.

5. The method according to claim 4, characterized in that the valency value (s) for a target pixel (zpix) is calculated according to the following rule:
s_{y,x}=(pix00-pix01)*(1.0-dy)−(pix10-pix11)*d_{y} wherein:
pix00=qpix00*(1.0-dₓ)
pix01=qpix01*dx
pix10=qpix10*(1.0-dₓ)
pix11=qpix11*dₓ.

6. The method according to one of the preceding claims, characterized in that the standard error (e) in the transformation of an image having the height (M) and the width (N) is determined according to the following rule:
M N
e=(ΣΣ[1-((1-f(x_{q},x_{hquell})f(y_{q}-y_{hquell})+1−((1-f_{xq+1},x_{hquell}) (1-f(y_{q+1},y_{hquell}))]/(M*N) wherein:
f(u,v)=−(u-v) if u-v>0
f(u,v)=u-v-1 if u-v>1
f(u,v)=0 otherwise.

7. A device for implementing the method according to one of the claims 1 to 6 characterized in that it has input terminals (1, 2, 3, 4), to which the corresponding pixel data (qpix00, qpix01, qpix10, qpix11) are supplied, as well as an output terminal (30) which supplies the data of the target image pixel (zpix).

8. The device according to claim 7 for implementing the method according to one of the claims 3 to 6, characterized in that it comprises clock-controlled changeover switches (18, 19, 20, 21) to which signals obtained from the weightings (d_{xq}, d_{yq}, d_{xq+1}, d_{yq+1}) are supplied in order to forward these selectively.
